(19) United States
(12) Patent Application Publication
(10) Pub. No.: US 2026/0147306 A1
(43) Pub. Date: May 28, 2026

(54) IMAGE FORMING APPARATUS

(71) Applicant: CANON KABUSHIKI KAISHA, Tokyo (JP)

(72) Inventor: FUMIYOSHI SAITO, Ibaraki (JP)

(21) Appl. No.: 19/392,970

(22) Filed: Nov. 18, 2025

(30) Foreign Application Priority Data
Nov. 25, 2024 (JP) 2024-204893

(51) Int. Cl. G03G 21/00; G03G 15/00; G03G 15/095; G03G 21/10

(52) U.S. Cl. CPC G03G 21/0047; G03G 15/095; G03G 15/80; G03G 21/0058; G03G 21/10; G03G 2215/0607

(57) ABSTRACT

An image forming apparatus includes a rotatable image bearing member, a developing device, a transfer member, a carrier collecting device including a rotatable sleeve provided opposed to the image bearing member and including a magnet provided non-rotatably inside the sleeve, a voltage applying portion configured to apply a voltage to the sleeve, and a controller configured to control the voltage applying portion so that a carrier collecting bias such that a pulse portion where a DC voltage and an AC voltage are superposed with each other and a blank portion including only of the DC voltage are periodically repeated is applied to the sleeve when an image forming operation is executed.

### BACKGROUND

### Field of the Technology

The aspect of the embodiments relates to an image forming apparatus provided with a carrier collecting device for collecting a carrier on an image bearing member.

### Description of the Related Art

As the image forming apparatus, a constitution in which a toner image is formed by using a two-component developer containing non-magnetic toner and a magnet carrier has been conventionally known. In this constitution, generally, in a developing step, an electrostatic latent image on a photosensitive drum is developed as a toner image with the toner, but the carrier is deposited on the photosensitive drum in a certain ratio in some cases (carrier deposition). When the carrier deposition occurs, it has an influence on an output image, and therefore, for example, in United State Patent Application Publication No. US2020/0292967 A1, a constitution provided with a carrier collecting device for collecting the carrier deposited on the photosensitive drum is disclosed.

In the carrier collecting device disclosed in US2020/0292967, a constitution in which a collecting roller and a magnet roller provided inside the collecting roller are provided and in which a voltage such that a DC voltage and an AC voltage are superposed with each other is applied is employed. By this, the carrier on the photosensitive drum is collected by a magnetic force of the magnet roller and an electrostatic force by an applied voltage.

In US2020/0292967, the voltage such that the DC voltage and the AC voltage are superposed with each other is applied to the collecting roller. As a condition of the applied voltage, for example, a rectangular wave such that the DC voltage is 0 to 800 V, the AC voltage is Vpp, of 800 to 2000 V, which is a difference between a maximum voltage and a minimum voltage, and a frequency is 500 to 2000 Hz is used.

The carrier is large in particle size (diameter) and is hard to vibrate compared with the toner, but when a vibration speed is made slow by lowering a frequency component of the AC voltage applied to the collecting roller, the carrier is also liable to be separated from the collecting roller by vibration. On the other hand, in the case where an AC voltage low in frequency is applied to the collecting roller, there is a liability that a variation of the toner due to re-arrangement in a collecting region of a carrier by the collecting roller becomes large, and thus an image on the photosensitive drum is disturbed.

### SUMMARY

According to the aspect of the embodiments, there is provided an image forming apparatus capable of executing an image forming operation, comprising: a rotatable image bearing member on which an electrostatic latent image is formed; a developing device including a developing container configured to accommodate a developer containing toner and a carrier and including a developer carrying member configured to carry the developer for developing the electrostatic latent image, formed on the image bearing member, into a toner image; a transfer member onto which the toner image borne on the image bearing member is transferred; a carrier collecting device including a rotatable sleeve provided opposed to the image bearing member on a side, with respect to a rotational direction of the image bearing member, downstream of a developing position where the electrostatic latent image formed on the image bearing member is developed and upstream of a transfer position where the toner image borne on the image bearing member is transferred onto the transfer member, and including a magnet provided non-rotatably inside the sleeve, the carrier collecting device being configured to collect the carrier on the image bearing member; a voltage applying portion configured to apply a voltage to the sleeve; and a controller configured to control the voltage applying portion so that a carrier collecting bias such that a pulse portion where a DC voltage and an AC voltage are superposed with each other and a blank portion including only of the DC voltage are periodically repeated is applied to the sleeve when the image forming operation is executed.

Features of the disclosure will become apparent from the following description of embodiments with reference to the attached drawings. The following description of embodiments are described by way of example.

### BRIEF DESCRIPTION OF THE DRAWINGS

FIG. 1 is a sectional view showing a structure of an image forming apparatus according to an embodiment.

FIG. 2 is a schematic view showing a structure of a developing device in the embodiment.

FIG. 3 is a schematic view showing a structure of a carrier collecting device in the embodiment.

FIG. 4 is a schematic view for illustrating a carrier collecting bias in the embodiment.

FIG. 5 is a schematic view for illustrating a duty ratio of the carrier collecting bias in the embodiment.

FIG. 6 is a schematic view for illustrating a carrier collecting bias waveform in a case of being influenced by rounding of the carrier collecting bias waveform.

### DESCRIPTION OF THE DRAWINGS

In the following, embodiments of the disclosure will be specifically described with reference to the attached drawings. Incidentally, the following embodiments do not limit the disclosure according to the range of the claims, and in addition, all of combinations of features described in the following embodiments are not necessarily essential to solution of the disclosure. The disclosure can be carried out in various purposes such as a copying machine, a printer, a facsimile machine, a multi-function machine having functions of these machines, and the like.

### [Image Forming Apparatus]

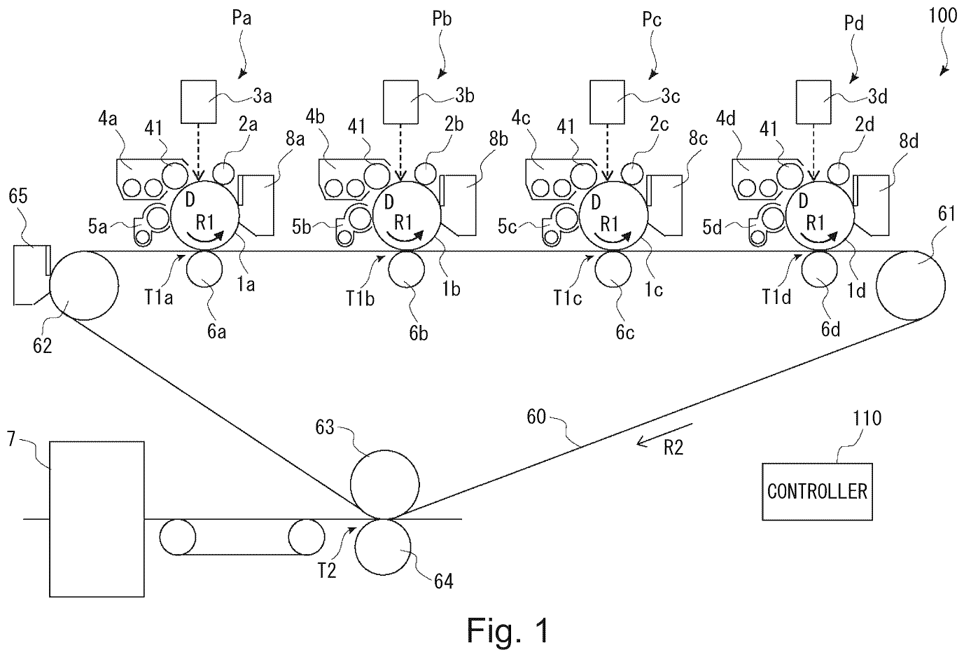

First, a general structure of an image forming apparatus according to an embodiment will be described using FIG. 1.

The image forming apparatus 100 of this embodiment is a full-color image forming apparatus 100 employing an electrophotographic type and includes four image forming potions Pa, Pb, Pc, and Pd. Incidentally, constitutions of the image forming portions are substantially the same except for development colors. For this reason, in the following, in the case where distinction is not particularly required, the image forming portion Pa is described as a representative, and other image forming portions Pb, Pc, and Pd will be omitted from description by adding suffixes b, c, and d showing associated constituent elements thereof to reference numerals or symbols of the constituent elements.

The image forming portion Pa includes a photosensitive drum 1a as an image bearing member for bearing an electrostatic latent image on a surface thereof. The photosensitive drum 1a is an example of a photosensitive member for electrophotography and is formed in a cylindrical shape. Such a photosensitive drum 1a is rotated in an arrow R1 direction (counterclockwise direction) in FIG. 1. At a periphery of the photosensitive drum 1a, a charging device 2a as a charging portion, a laser beam scanner 3a as a latent image forming portion, a developing device 4a, a carrier collecting device 5a, a primary transfer roller 6a, a cleaning device 8a, and the like are provided.

Next, an image forming sequence (image forming operation) of entirety of the above-constituted image forming apparatus 100 will be described. First, the surface of the photosensitive drum 1a is electrically charged uniformly to a predetermined charged potential by the charging device 2a. The photosensitive drum 1a charged by the charging device 2a is then subjected to scanning exposure to laser light modulated with an image signal by a laser beam scanner 3a which is an example of an exposure device.

The laser beam scanner 3a is controlled on the basis of inputted image data, and the image data for emitting laser light is inputted from, for example, an external terminal such as an original reading apparatus or a personal computer (PC). By the laser light of the laser beam scanner 3a, a surface potential of the photosensitive drum 1a charged by the charging device 2a changes in an image portion, so that the electrostatic latent image is formed on the photosensitive drum 1a.

Thus, the electrostatic latent image formed on the photosensitive drum 1a is reversely developed with toner into a visible image, i.e., a toner image. In this embodiment, the developing device 4a uses a two-component development type in which a developer containing non-magnetic toner as the developer and a magnetic carrier is used. Each of the developing devices 4a, 4b, 4c, and 4d includes a developing container accommodating a two-component developer containing toner of an associated color. Specifically, the developing devices 4a, 4b, 4c, and 4d accommodate toner of yellow (Y), toner of magenta (M), toner of cyan (C), and toner of black (K), respectively. Accordingly, the above-described steps are performed for each of the image forming portions Pa, Pb, Pc, and Pd, so that toner images of the four colors of yellow, magenta, cyan, and black are formed on the photosensitive drums 1a, 1b, 1c, and 1d, respectively.

Further, in a position under the image forming portions Pa, Pb, Pc, and Pd, an intermediary transfer belt 60 which is an intermediary transfer member is provided. The intermediary transfer belt 60 is stretched by rollers 61, 62, and 63, and is movable in an arrow R2 direction. Outside the intermediary transfer belt 60 stretched by the roller 63, a secondary transfer roller 64 is provided. The secondary transfer roller 64 is constituted so that a recording material is capable of passing through between itself and the intermediary transfer belt 60. Incidentally, the recording material is, for example, a sheet such as paper or a plastic sheet.

The toner images on the photosensitive drums 1a, 1b, 1c, and 1d are primarily transferred successively onto the intermediary transfer belt 60 in primary transfer portions T1a, T1b, T1c, and T1d as transfer portions by primary transfer rollers 6a, 6b, 6c, and 6d as primary transfer members. By this, on the intermediary transfer belt 60, the toner images of yellow, magenta, cyan, and black are superposed, so that a full-color image is formed. Further, toner remaining on the photosensitive drum 1a without being transferred onto the intermediary transfer belt 60 is collected by the cleaning device 8a.

This full-color image on the intermediary transfer belt 60 is secondarily transferred onto a recording material fed form an unshown feeding portion by the action of the secondary transfer roller 64 in a secondary transfer portion T2 formed by the secondary transfer roller 64 and the intermediary transfer belt 60. Toner remaining on a surface of the intermediary transfer belt 60 without being transferred onto the recording material is collected in an intermediary transfer belt collecting device 65. On the other hand, the recording material on which the toner image is transferred is sent to fixing device 7, in which fixing of the image is formed, and then is discharged to an outside of the image forming apparatus 100.

The carrier collecting device 5a is disposed opposed to the photosensitive drum 1a on a side downstream of the developing device 4a and upstream of the primary transfer portion T1a with respect to a rotational direction R1 of the photosensitive drum 1a. Similarly, the carrier collecting devices 5b, 5c, 5d and disposed opposed to the photosensitive drums 1b, 1c, and 1d, respectively, on sides downstream the developing devices 4b, and 4d, respectively, and upstream of the primary transfer portions T1b, T1c, and T1d, respectively, with respect to the rotational directions R1 of the photosensitive drums 1b, 1c, and 1d, respectively.

The toner with which the electrostatic latent image is developed in a developing region and the carrier unintentionally transferred from the developing device 4a to the photosensitive drum 1a pass through the developing region, and then are conveyed to the carrier collecting device 5a with rotation of the photosensitive drum 1a. Similarly, the toner with which the electrostatic latent image is developed in the developing region and the carrier transferred on the photosensitive drums 1b, c, and 1d pass through the developing region, and then are conveyed to the carrier collecting devices 5b, 5c, and 5d with rotation of the photosensitive drums 1b, 1c, and 1d.

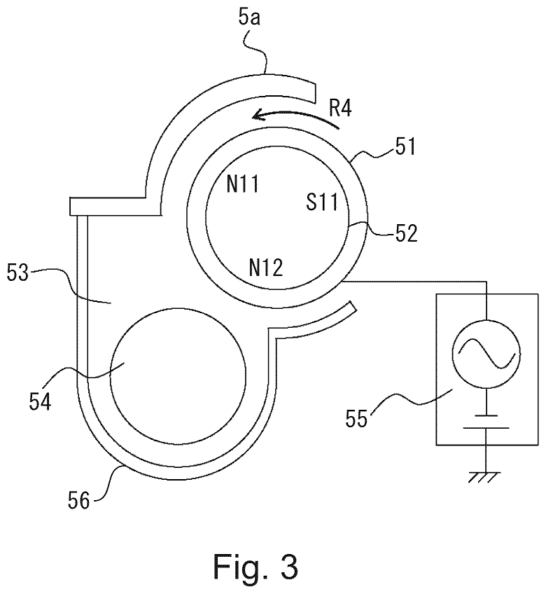

The carrier collecting devices 5a, 5b, 5c, and 5d are provided for the purpose of collecting the carriers transferred on the photosensitive drums 1a, 1b, 1c, and 1d. Details of the carrier collecting devices 5a, 5b, 5c, and 5d will be described with reference to FIG. 3.

### (Constitution of Developing Device)

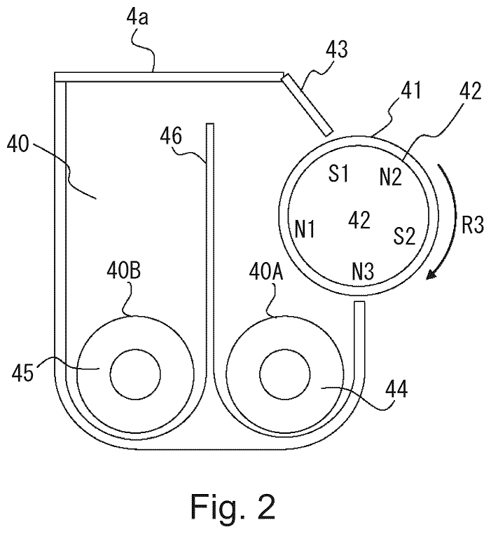

Next, the developing devices 4a, 4b, 4c, and 4d in this embodiment will be described using FIG. 2 while making reference to FIG. 1. FIG. 2 is a sectional view showing a constitution of the developing device 4a. Constitutions of the developing devices 4a, 4b, 4c, and 4d are the same, and therefore, in the following, as a representative, the developing device 4a will be described.

In this embodiment, the developer accommodated in the developing device 4a is the two-component developer in which negatively chargeable non-magnetic toner and the magnetic carrier are mixed. The non-magnetic toner (hereinafter, referred to as the toner) is one in the form of powder prepared by incorporating a colorant, a wax component, and the like into resin such as polyester, styrene, or the like and then by pulverizing or polymerizing a resultant mixture. The magnetic carrier (hereinafter, referred to as the carrier) is one obtained by subjecting a surface layer of a core consisting of resin particles in which ferrite particles or magnetic powder is kneaded, to resin coating.

The developing device 4a is provided with a developing container 40 accommodating the two-component developer, a developing sleeve 41 as a developer carrying member, and a magnet roller 42 consisting of a magnet as a magnetic force generating means fixed and disposed in the developing sleeve 41. Further, a regulating blade 43 for forming a thin layer on a surface of the developing sleeve 41, and screw members 44 and 45 for stirring and conveying the developer in the developing container 40 are provided.

An inside of the developing container 40 is partitioned into a developing chamber 40A and a stirring chamber 40B by a partition wall 46 extending in a vertical direction. In each of opposite end portions of the partition wall 46 with respect to a longitudinal direction, a delivering portion (not shown) for permitting passing of the developer between the developing chamber 40A and a stirring chamber 40B is provided.

The developing chamber 40A is provided with an opening in a position corresponding to the developing region opposing the photosensitive drum 1, and in this opening of the developing container 40, the developing sleeve 41 is rotatably disposed so as to be partially exposed.

In this embodiment, the developing sleeve 41 is constituted by a non-magnetic material and is rotated in an arrow direction in FIG. 2 during a developing operation. Further, inside the developing sleeve 41, as a magnetic field generating means, the magnet roller 42 having a plurality of magnetic poles along a circumferential direction thereof is fixed.

In this embodiment, the magnet roller 42 on which five magnetic poles are polarized was used. An N1 pole is an attracting magnetic pole for carrying the developer, sent from the screw member 44, to the developing sleeve 41. An S1 pole is a layer thickness regulating magnetic pole for regulating a conveying amount of the developer conveyed to the developing region.

An N2 pole is a conveying magnetic pole for conveying the developer. An S2 pole is a developing magnetic pole contributing to the development. An N3 pole is a peeling magnetic pole for peeling off the developer carried on the developing sleeve 41. With respect to a rotational direction R3 of the developing sleeve 41, a repelling magnetic field is formed between the N3 pole and the N1 pole.

The developer in the developing chamber 40A is supplied to the developing sleeve 41 by the screw member 44. The developer supplied to the developing sleeve 41 is carried on the developing sleeve 41 in a predetermined amount by the attracting magnetic pole N1 generated by the magnet roller 42 and forms a developer gathering portion.

The two-component developer on the developing sleeve 41 is conveyed to the layer thickness regulating magnetic pole S1 by rotation of the developing sleeve 41, so that a layer thickness of the developer is regulated by the regulating blade 43.

The regulating blade 43 is constituted by a non-magnetic member formed with a plate-like stainless steel extending along a rotational axis of the developing sleeve 41 and is disposed on a side upstream of a position opposing the photosensitive drum 1a with respect to the rotational direction (arrow R3 direction) of the developing sleeve 41. Then, both the toner and the carrier of the developer pass through between a free end portion of the regulating blade 43 and the developing sleeve 41, and in addition, are conveyed toward the developing region opposing the photosensitive drum 1 by the conveying magnetic pole N2, so that the toner is supplied to the electrostatic latent image.

Thereafter, the developer on the developing sleeve 41 is peeled off from the surface of the developing sleeve 41 by the peeling magnetic pole S3.

In this embodiment, a diameter of the developing sleeve 41 is 20 mm, and a diameter of the photosensitive drum 1 is 30 mm. Further, a rotational linear speed of the developing sleeve 41 is made faster than a rotational linear speed of the photosensitive drum 1, so that an amount of developer magnetic chains, per unit area, contacting the photosensitive drum 1 is made large, and thus an amount of the toner capable of being supplied is made large. In this embodiment, the rotational linear speed was 400 mm/s, and the rotational linear speed of the developing sleeve 41 was 600 mm/s which is obtained by multiplying 400 mm/s by a peripheral speed ratio of 1.5

Further, in this embodiment, a closest region between the developing sleeve 41 and the photosensitive drum 1 is caused to have a distance of about 250 μm. By this constitution, a setting is made so as to perform the development in a state in which the developer conveyed to the developing region is contacted to the photosensitive drum 1.

In this embodiment, a voltage applied to the charging device 2 is a sine wave including a DC voltage of −530 V, a peak-to-peak voltage of 1200 V, and a frequency of 2000 Hz. Incidentally, a charge potential Vd of the photosensitive drum 1 is different between immediately after the charging and in the developing region due to dark decay. The same applies to an exposure potential Vl, and each of the charge potential Vd and the exposure potential Vl refers to a value in the developing region. In this embodiment, the charge potential Vd was-700 V, and the exposure potential Vl was-300 V.

To the developing sleeve 41, a developing bias obtained by superposing a DC voltage (developing Vdc) and an AC voltage with each other is applied. In this embodiment, the developing bias was a rectangular wave including a DC voltage of −550 V, a peak-to-peak voltage of 1400 V, a frequency of 12000 Hz, and a duty ratio of 50%.

By an electric field formed by the charge potential Vd, the developing potential Vdc, and the exposure potential Vl of the developing sleeve 41 and the photosensitive drum 1, toner with a negative polarity existing in the developer is changed to the exposure potential on the photosensitive drum 1 by development of the electrostatic latent image. When the electrostatic latent image is developed, a potential of an exposure portion is changed by an electric charge of the toner.

The potential of the exposure portion after the development is defined as a toner potential. After passing through the developing region, in general, the toner potential becomes a potential substantially equal to the developing potential Vdc.

On the other hand, the carrier with a positive polarity receives Coulomb force by which the carrier is moved in a direction from the developing sleeve 41 to the photosensitive drum 1 in a region of the charge potential Vd on the photosensitive drum 1. On the other hand, the carrier which is a magnetic material is attracted to the developing sleeve 41 by a magnetic force formed by the developing pole S2 with magnetic flux density of 120 mT. Most of the carrier is not transferred onto the photosensitive drum 1. However, in some cases, only a part of a carrier with a small diameter or a carrier with low magnetization is small in magnetic force and therefore, such a carrier is transferred from the developing sleeve 41 onto the photosensitive drum 1 by the Coulomb force. When the carrier is transferred from the developing sleeve 41 on the photosensitive drum 1, the image defect as described above occurs in some cases.

### (Carrier Collecting Device)

Next, the carrier collecting devices 5a, 5b, 5c, and 5d in this embodiment will be described using FIG. 3 by making reference to FIG. 1. FIG. 3 is a sectional view showing a constitution of the carrier collecting device 5. Constitutions of the carrier collecting devices 5a, 5b, 5c, and 5d are the same, and therefore, in the following, as a representative, the carrier collecting device 5a will be described.

The carrier collecting device 5a collects the carrier deposited on the photosensitive drum 1 (carrier on the image bearing member) on a side downstream of a developing portion D and upstream of the primary transfer portion T1a with respect to the rotational direction (arrow R1 direction) of the photosensitive drum 1a as shown in FIG. 1. The developing portion D refers to a region in which the developing device 4a and the photosensitive drum 1 are close to each other. The primary transfer portion T1a is a region where the primary transfer roller 6a and the photosensitive drum 1a are close to each other.

The carrier collecting device 5a includes a collecting sleeve 51 (collecting roller) which is provided opposed to the photosensitive drum 1a and which is rotatable. Further, the carrier collecting device 5a includes, as shown in FIG. 3, a magnet roller 52 (magnet) non-rotatably provided inside the collecting sleeve 51 and used as a magnetic field generating portion such that the carrier is attracted to the surface of the collecting sleeve 51 by a magnetic force. Further, the carrier collecting device 5a includes, as shown in FIG. 3, a collecting chamber 53 and a conveying screw 54 for conveying the carrier collected in the collecting chamber 53. These chamber and screw disposed in a collecting container 56.

In this embodiment, the collecting sleeve 51 is 18 mm in diameter and is disposed with a gap of about 250 μm in a closest region to the photosensitive drum 1a, and conveys the collected carrier by being rotated and driven in an arrow R4 in FIG. 3.

The magnet roller 52 as a carrier conveying means on the collecting sleeve 51 and as a carrier peeling means includes a plurality (three in this embodiment) of magnet poles (magnet pieces). An S11 pole (carrier collecting pole) is provided in a position opposing the photosensitive drum 1a through the collecting sleeve 51. The S11 pole in a magnetic pole for attracting the carrier deposited on an outer peripheral surface of the photosensitive drum 1a. The S11 pole is disposed in the neighborhood of a closest position between the photosensitive drum 1a and the collecting sleeve 51. By a magnetic field generated by the S11 pole and an electric field generated by a carrier collecting bias described later, the carrier deposited on the photosensitive drum 1a is attracted to the surface of the collecting sleeve 51.

An N11 pole (carrier conveying pole) is provided adjacently to the S11 pole on a side downstream of the S11 pole with respect to the rotational direction (arrow R4 direction) of the collecting sleeve 51 and is different in polarity from the S11 pole. By a magnetic force generated by the S11 pole and the N11 pole, the carrier attracted to the surface of the collecting sleeve 51 is conveyed with rotation of the collecting sleeve 51.

An N12 pole (collecting peeling pole) is provided adjacently to the N11 pole on a side downstream of the N11 pole with respect to the rotational direction of the collecting sleeve 51 and has the same magnetic polarity as the N11 pole. The N12 pole is a magnetic pole for peeling the conveyed carrier and for collecting the carrier into the collecting chamber 53. The carrier is peeled off from the surface of the collecting sleeve 51 into the collecting chamber 53 by a repelling magnetic field generated by the N11 pole and the N12 pole with rotation of the collecting sleeve 51.

In the following, description will be made specifically. The collecting sleeve 51 is disposed opposed to the photosensitive drum 1a on a side downstream of the developing portion D (developing position) and upstream of the primary transfer portion T1a (transfer position) with respect to the rotational direction of the photosensitive drum 1. The collecting sleeve 51 is rotated in the arrow R4 direction in FIG. 3, and the carrier deposited on the photosensitive drum 1a is attracted to the surface of the collecting sleeve 51 by a magnetic field generated by the S11 pole disposed at a periphery of a position close to the photosensitive drum 1a.

The attracted carrier is conveyed with rotation of the collecting sleeve 51 and is peeled off into the collecting chamber 53 by a repelling magnetic field generated by the N11 pole and the N12 pole.

The conveying screw 54 as a carrier conveying member includes a rotation shaft made of non-magnetic metal and a blade formed of a resin in a helical shape at a periphery of the rotation shaft. Further, the conveying screw 54 is rotated and conveys the carrier, dropped from the collecting sleeve 51, in a rotational axis direction of thereof by rotation thereof. In this embodiment, the rotational axis direction of the conveying screw 54 and a rotational axis direction of the collecting sleeve 51 are made substantially parallel to each other.

In this embodiment, the magnet roller 52 was employed as the carrier conveying means and the carrier peeling means, but these means are not limited thereto. For example, as the carrier conveying means, an “electric field curtain type” in which charging particles are placed on a linear electrode group and a voltage changing with time is successively applied to this electrode group to form an electric field providing a progressive wave and in which the charging particles are conveyed by an electrostatic force at that time may be employed. Further, as the carrier peeling means, a constitution such as a scraper or a cleaning blade for physically peeling the carrier in contact with the collecting sleeve 51 may be employed.

Further, to the collecting sleeve 51, from a power source 55 (collecting high-voltage substrate) as a voltage applying portion, a superposed (superimposed) voltage of a DC voltage and an AC voltage is applied. The power source 55 is controlled by a controller 110 (FIG. 1) of the image forming apparatus 100, and when the image forming operation is executed, the DC voltage and the AC voltage are capable of being applied in a superposed manner depending on an operation of the carrier collecting device 5a.

The carrier collecting device 5a collects the carrier deposited on the photosensitive drum 1a, by a force due to a magnetic field formed by the magnet roller 52 and by a force due to an electric field, between the collecting sleeve 51 and the photosensitive drum 1, formed by the voltage applied to the collecting sleeve 51.

### (Carrier Collecting Bias)

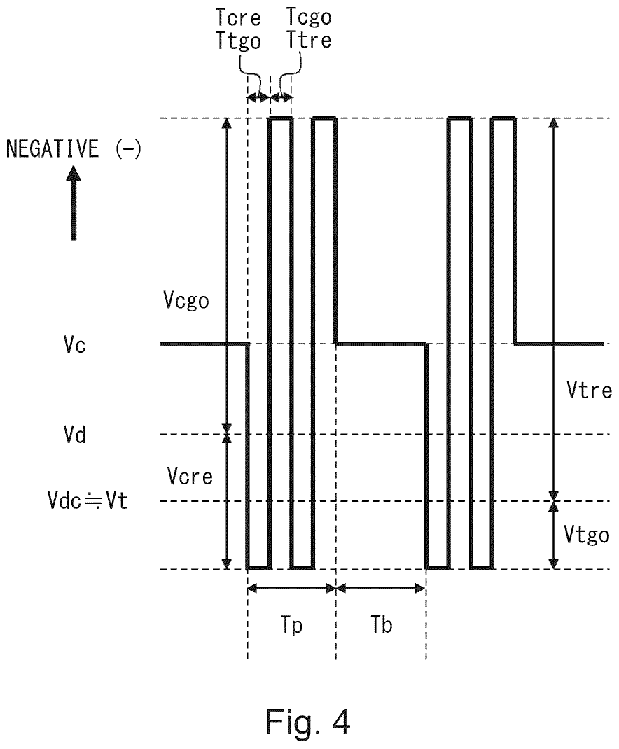

Subsequently, the carrier collecting bias which is a feature of this embodiment will be described using FIG. 4. In FIG. 4, an ordinate represents a potential and an abscissa represents a time, and the ordinate shows the potential so that an upper portion shows a negative (−) value.

The carrier collecting bias is applied to the collecting sleeve 51 by the power source 55 when the image forming operation is executed.

A waveform of the carrier collecting bias in a conventional example was a rectangular bias in which a rectangular pulse portion with a relatively low frequency such that a DC voltage is biased (super(im)posed with) an AC voltage is repeated.

On the other hand, a waveform of the carrier collecting bias in this embodiment is, as shown in FIG. 4, characterized in that a pulse portion in which a DC voltage is biased with an AC voltage and a blank portion including only of the DC voltage are periodically repeated. In other words, the waveform of the carrier collecting bias in this embodiment is a blank pulse waveform such that a portion including the DC voltage is provided by intermittently thinning the AC voltage.

By providing the blank portion, a performance for collecting the carrier from the photosensitive drum 1 onto the collecting sleeve 51 can be improved. On the other hand, by increasing a frequency of the pulse portion, the toner image obtained by developing the electrostatic latent image can be rearranged on the photosensitive drum 1 in a carrier collecting region of the collecting sleeve 51 without being disturbed, so that it is possible to suppress that an image on the photosensitive drum 1 is disturbed.

The carrier collecting bias shown in FIG. 4 is a double blank pulse (WBP) such that a blank portion (time: Tb) is provided after a pulse portion (time: Tp) consisting of an AC voltage with a two-(cyclic) period rectangular wave. A length of the blank portion is a time equivalent to two periods (wavelength) of the rectangular wave of the pulse portion.

Here, Vc, Vcgo, Vcre, Vtge, Vtre, Tcgo, and Tcre of a waveform of the carrier collecting bias shown in FIG. 4 are defined as follows:
Vd: The DC voltage of the carrier collecting bias, which is a voltage of the blank portion
Vcgo: Of the AC voltage of the pulse portion, a voltage on a side opposite in polarity to a normal charge polarity (positive polarity) of the carrier relative to the predetermined charge potential Vd
Vcre: Of the AC voltage of the pulse portion, a voltage on a side identical in polarity to the normal charge polarity (positive polarity) of the carrier relative to the predetermined charge potential Vd
Vtgo: Of the AC voltage of the pulse portion, a voltage on a side opposite in polarity to the normal charge polarity (negative polarity) of the toner relative to a predetermined toner potential Vt
Vtre: Of the AC voltage of the pulse portion, a voltage on a side identical in polarity to the normal charge polarity (negative polarity) of the toner relative to the predetermined toner potential Vt
Vcgo (=Vtre): An application time of Vcgo (Vtre) in one (cyclic) period of the pulse portion
Vcre (=Vtgo): An application of Vcre (Vtgo) in one period of the pulse portion

Vc is the DC voltage of the carrier collecting bias and Vc=−900 V in this embodiment, and has a potential difference of 200 V from the charge potential Vd=−700.

Vcgo is a carrier collection driving-side component based on the charge potential Vd. The carrier collection driving-side component is a voltage at which a force of a normal charge carrier (positive polarity) acts in a direction from the photosensitive drum 1 to the collecting sleeve 51.

Vcre is a carrier returning component based on the charge potential Vd. The carrier returning component is a voltage at which the force of the normal charge carrier (positive polarity) acts in a direction from the collecting sleeve 51 to the photosensitive drum 1.

Vtgo is a toner collection driving-side component based on the toner potential Vt. The toner collection driving-side component is a voltage at which a force of a normal charge toner (negative polarity) acts in the direction from the photosensitive drum 1 to the collecting sleeve 51.

Vtre is a voltage returning component based on the toner potential Vt. The toner returning component is a voltage at which the force of the normal charge toner (negative polarity) acts in the direction from the collecting collect 51 to the photosensitive drum 1.

Incidentally, in this embodiment, description was made based on that the normal charge polarity of the toner is the negative polarity and the normal charge polarity of the carrier is the positive polarity, but this embodiment is not limited thereto. A modified embodiment in which the normal charge polarity of the toner is the positive polarity and the normal charge polarity of the carrier is the negative polarity may also be employed.

Further, in the case where the normal charge polarity of the toner (carrier) is the negative (positive polarity), even when the voltage is on the side opposite in polarity, to the normal charge polarity of the toner (carrier) does not mean the voltage of the positive (negative) polarity. That is, the voltage means a voltage on a positive (negative)-polarity side relative to a base potential (Vt or Vd), and in the case where the developing bias of the negative polarity is applied as in this embodiment, even when the polarity of the voltage is on the side opposite to the normal charge polarity of the toner (carrier) is the negative polarity. However, in some cases, the polarity is the positive polarity.

When the waveform is shifted from the pulse portion to the blank portion, the waveform is constituted so that the blank portion is continuous immediately after application of a voltage of the carrier collecting driving-side component of the AC voltage, i.e., an opposite polarity (negative polarity) side component to the normal charge polarity (positive polarity in this embodiment) of the carrier.

This is because the blank portion is liable to have the influence of an immediately-before state and a carrier collecting performance can be improved when the blank portion is made continuous immediately after the voltage application of the carrier collection driving-side component. Further, when the blank portion is made continuous immediately after the voltage application of the carrier collection driving-side component, there is an advantage such that the toner with which the electrostatic latent image is developer is also hard to be deposited on the collecting sleeve 51.

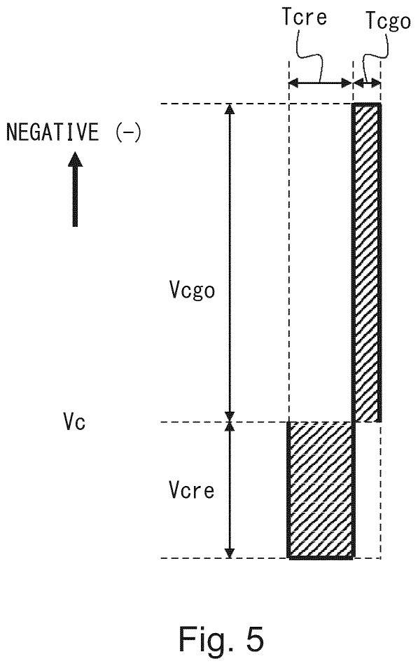

Here, a duty waveform change in a duty ratio of the carrier collecting bias will be described using FIG. 5. First, as described above with reference to FIG. 4, of the pulse portion of the AC voltage, an applied voltage of the carrier collecting driving-side component is Vcgo and an applied voltage of the carrier returning component is Vcre. In this case, a ratio of the carrier collection driving-side component Vcgo to entirety (Vcgo+Vcre) of the carrier collecting bias, i.e., Vcgo/(Vcgo+Vcre) is referred to as a duty ratio (unit: %).

At this time, the application time Tcgo of the carrier collection driving-side component and the application time Tcre of the carrier returning component are changed so as to provide a ratio roughly reverse to a ratio between the above-described applied voltages (Tcgo:Tcre=Vcre:Vcgo). For this reason, in one (cyclic) period of the AC voltage, an integrated value of the carrier collection driving-side component and an integrated value of the carrier returning component are substantially constant. That is, in FIG. 5, an area Vcgo×Tcgo of an upper-side hatched portion than Vc and an area Vcre×Tcre of a lower-side hatched portion than Vc satisfy Vcgo×Tcgo=Vcre×Tcre. By making such a setting, in one embodiment, an effective voltage level can be made substantially constant between the pulse portion in which the AC voltage and the DC voltage are superposed with each other and the blank portion including only of the DC component.

Incidentally, as described above, the duty ratio was defined as Vcgo/(Vcgo+Vcre) on the basis of the applied voltages, but the duty ratio is not limited thereto. The duty ratio may also be defined as Tcre/(Tcgo+Tcre).

Incidentally, in experiments in this embodiment, a carrier collecting bias waveform was measured using an oscilloscope (Model: “DPO2014B”, manufactured by Tektoronix, Inc.). The carrier collecting bias waveform is liable to have the influence of a degree of rounding due to a change in electrostatic capacity or the like between the collecting sleeve 51 and the photosensitive drum 1 during output. For this reason, in the experiments in this embodiment, in the case where the duty ratio is calculated by actually measuring the carrier collecting bias waveform, the duty ratio is calculated on the basis of the application times, not the applied voltages because the applied voltages are particularly liable to have the influence of the rounding.

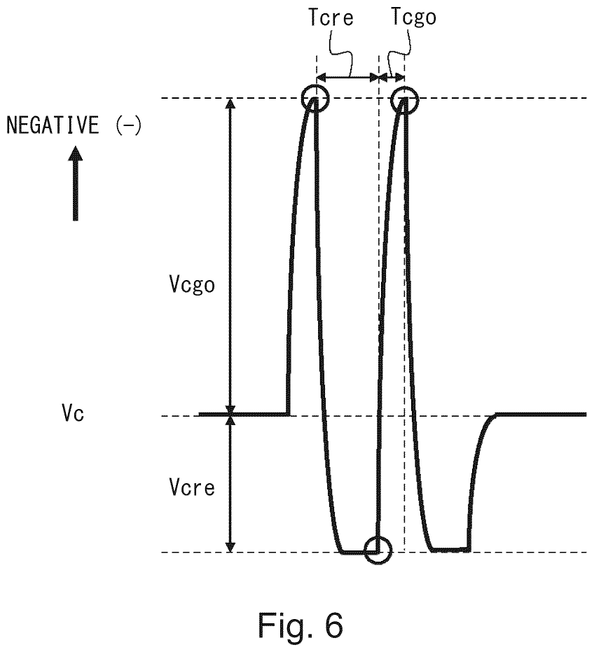

FIG. 6 shows an example of the carrier collecting bias waveform in the case where the carrier collecting bias waveform has the influence of the rounding. The rounding of the carrier collecting bias waveform is a delay of response of a potential due to a transient phenomenon generated in the case where the potential is changed. For this reason, a state of the potential is liable to have the influence of the electrostatic capacity or the like, but a timing when the potential is changed is less liable to have the influence of the electrostatic capacity or the like. Therefore, in the experiments in this embodiment, the duty ratio is calculated on the basis of potential change start timings each enclosed by a circle in FIG. 6.

Here, an effect of a blank pulse waveform applied to the collecting sleeve 51 will be specifically described.

The normal charge carrier (positive in this embodiment), deposited on the surface of the photosensitive drum 1, forming the charge potential Vd is principally deposited by the Coulomb force.

In the carrier collecting region, a force for peeling of the normal charge carrier deposited on the surface of the photosensitive drum 1 from the photosensitive drum 1 is imparted by a magnetic force by the carrier collecting pole and the Coulomb force by the carrier collection driving-side component Vcgo in the pulse portion of the carrier collecting bias. As a result, the normal charge carrier is removed from the photosensitive drum 1. On the other hand, the removed normal charge carrier is moved toward a direction of the photosensitive drum 1 by the Coulomb force by the carrier returning component and is deposited again on the photosensitive drum 1 in some cases.

In the case of the rectangular bias in the comparison example (i.e., the rectangular bias such that the rectangular pulse portion with the relatively low frequency in which the DC voltage is biased with the AC voltage), the normal charge carrier reaches the collecting sleeve 51 while being reciprocated by the Coulomb force due to Vcgo and Vcre.

Here, when the frequency of the pulse portion is high, the carrier is hard to follow the carrier collecting bias and is hard to reach the collecting sleeve 51 in the carrier collecting region, and therefore, the carrier collecting performance lowers.

Here, in the case where the blank portion is provided after an end of voltage application of the carrier collection driving-side component of the pulse portion, a force toward the collecting sleeve 51 acts for a certain period in a state in which the normal charge carrier is removed from the photosensitive drum 1. As a result, a movement distance of the carrier from the photosensitive drum 1 toward the collecting sleeve 51 becomes long, so that the collecting performance is improved.

When the carrier collecting performance can be improved, the frequency of the pulse portion can be made higher than a conventional frequency, so that it is possible to reduce a variation in toner deposition onto a non-image portion in toner re-arrangement in the carrier collecting region. Further, in the toner re-arrangement, the toner of an image portion becomes hard to be collected by the collecting sleeve 51 in combination with small electric field strength of the toner collection driving-side component, the blank portion is capable of suppressing a lowering in image quality.

Further, by changing the duty ratio of the carrier collecting bias, the carrier collecting performance can be further improved, so that it is possible to reduce the lowering in image quality in the toner re-arrangement. Specifically, by making the duty ratio 50% or more and 90% or less, the carrier collection driving-side component of the pulse portion becomes large and thus the carrier is liable to be removed from the photosensitive drum 1, so that the carrier collecting performance is improved. On the other hand, when the duty ratio is made 50% or more and 90% or less, the toner collection driving-side component is also decreased, and similarly as in the blank portion, the toner in the image portion becomes hard to be collected by the collecting sleeve 51, so that the lowering in image quality can be suppressed.

Further, the duty ratio can also be made variable depending on a temperature/humidity in which the image forming apparatus 100 is installed. In the case where the image forming apparatus 100 is installed in an environment of a small water content, a charge amount of the carrier increases in general. When the charge amount of the carrier increases, an electrostatic depositing force of the carrier between the photosensitive drum 1 and the carrier increases, so that the carrier becomes hard to be removed from the photosensitive drum 1. Accordingly, by making the duty ratio higher with a smaller water content environment, it becomes possible to maintain the carrier collecting performance.

Further, relative to the frequency of the pulse portion of the developing bias, the frequency of the pulse portion of the carrier collecting bias or the duty ratio is made larger, compared with an image quality before the carrier passes through the carrier collecting region, an image quality after the carrier passes through the carrier collecting region can be made better.

As described above, determination of an image property on the photosensitive drum 1 is large in contribution thereof to a downstream step of the image forming process. Accordingly, the toner collection driving-side component is reduced by making the frequency of the pulse portion of the carrier collecting bias higher than the frequency of the pulse portion of the developing bias or by increasing the duty ratio. By this, the variation in toner deposition onto the non-image portion due to the toner re-arrangement in the carrier contact region is more reduced than that after the carrier passes through the developing region, so that the image quality can be improved.

### EMBODIMENT

An experiment conducted for the carrier collecting performance and the image quality when the waveform of the carrier collecting bias is changed will be described. In this experiment, a length of the blank portion of the carrier collecting bias, a duty ratio, and a frequency of the pulse portion of the carrier collecting bias are principally changed.

In one embodiment, evaluation of the carrier collecting performance was performed in a manner such that line images which are single-color images of magenta and which are about 0.6 in reflect density and 212 lines/inch in resolution were outputted from only the image forming portion Pb of the image forming portions Pa, Pb, Pc, and Pd of the image forming apparatus 100, and then the number of spot-like images with gradation were evaluated. When the carrier exists on the photosensitive drums 1 of the image forming portions (Pc, Pd) on a side downstream of the image forming portion Pb from which the output images were formed, re-transfer of the output images are prevented by the primary transfer rollers 6c and 6d, so that the spot-like images are formed.

The reflection density was measured by a spectral densitometer (“X-Rite 504/508”, manufactured by X-Rite, Inc.). It has already been known from previous sensitive evaluation that the spot-like image with gradation is liable to be conspicuous in the neighborhood of the reflection density of 0.5 to 0.8 particularly in terms of sensitivity of human eyes.

A setting such that the number of the carrier on the photosensitive drum 1 after passing through the developing region and before passing through the collecting region is one (particle)/cm² (1247 particles/A3-size sheet) was made, and the magenta (single-color) image was outputted on 10 A3-size sheets. Evaluation was performed in a manner such that with respect to an average number of the spot-like images with gradation per (one) A3-size sheet, one or less was evaluated as “⊚”, from one to two or less was evaluated as “◯”, from two or more and ten or less was evaluated as “Δ”, and ten or more was evaluated as “X”.

Further, as an index of the image quality, roughness of an image was evaluated. Evaluation of the roughness was performed using line images which are about 0.4 in reflection density and 212 lines/inch in resolution. It has already been known from previous sensitive evaluation that the roughness of the image is liable to be conspicuous in the neighborhood of the reflection density of 0.3 to 0.5 particularly in terms of sensitivity of human eyes. Evaluation was performed in a manner such that with respect to the line images, those with no roughness and which are particularly smooth are evaluated as “⊚”, those with no roughness and which are smooth are evaluated as “◯”, those of which roughness is not conspicuous and which are smooth are evaluated as “Δ”, and those of which roughness is conspicuous are evaluated as “X”

In both the carrier collecting performance evaluation and the roughness evaluation, in one embodiment, a result of at least the evaluation of “A” is required.

The result of the carrier collecting performance evaluation and the roughness evaluation in constitutions of carrier collecting biases in this experiment is shown in table 1 below.

In the table 1, a waveform “WEP” shows that the waveform of the developing bias is a double blank pulse waveform such that a blank portion is provided after the pulse portion consisting of an AC voltage of a two-period rectangular wave. Further, in the table 1, a waveform “RECTANGLE” shows that the waveform is a developing bias waveform with no timing of the AC voltage (i.e., with no blank portion). Further, in the table 1, a waveform “Vpp” shows a peak-to-peak voltage.

TABLE 1

| | COMP. EX1 | | COMP. EX. 2 | | EMB. 1-1 | | EMB. 1-2 | | EMB. 1-3 | | EMB. 2 | | EMB. 3 | |
|---|---|---|---|---|---|---|---|---|---|---|---|---|---|---|
| WAVEFORM | RECT*1 | | RECT*1 | | WBP | | WBP | | WBP | | WBP | | WBP | |
| Vpp | 1.0 | kV | 1.0 | kV | 1.0 | kV | 1.0 | kV | 1.0 | kV | 1.0 | kV | 1.0 | kV |
| PPF*2 | 10 | kHz | 2.5 | kHz | 10 | kHz | 10 | kHz | 10 | kHz | 10 | kHz | 15 | kHz |
| BPL*3 | NO | | NO | | 1 WL | | 2 WL | | 4WL | | 1WL | | 1WL | |
| DUTY RATIO | 50% | | 50% | | 50% | | 50% | | 50% | | 70% | | 50% | |
| Vcgo | 0.5 | kV | 0.5 | kV | 0.5 | kV | 0.5 | kV | 0.5 | kV | 0.7 | kV | 0.5 | kV |
| Vcre | 0.5 | kV | 0.5 | kV | 0.5 | kV | 0.5 | kV | 0.5 | kV | 0.3 | kV | 0.5 | kV |

| | | | | | | | |
|---|---|---|---|---|---|---|---|
| CCPE*4 | X | ◯ | ◯ | ◯ | Δ | ⊚ | Δ |
| RE*5 | ◯ | X | ◯ | ◯ | Δ | ⊚ | ⊚ |

*1: “RECT” is rectangle.
*2: “PPF” is pulse portion frequency.
*3: “PBL” is blank portion length. “WL” is wavelenth(s).
*4: “CCPE” is carrier collection performance evaluation.
*5: “RE” is roughness evaluation.

In a comparison example 1, the developing bias is a rectangular bias and a frequency of a pulse portion is a high frequency. In the comparison example 1, the roughness evaluation is good, but the carrier collecting performance evaluation is low, so that an original function as the carrier collecting device is not sufficiently achieved.

In comparison example 2, the developing bias is a rectangular bias and a frequency of a pulse portion is a low frequency. In the comparison example 2, the carrier collecting performance evaluation is good, but the roughness evaluation lowers, so that compatibility between the carrier collecting performance and the image quality cannot be achieved.

It is understood that it is difficult to compatibly realize the carrier collecting performance evaluation and the roughness evaluation only by changing the frequency as in the comparison examples 1 and 2.

In an embodiment 1-1, the developing bias is a waveform with a blank portion having a length corresponding to one wavelength. In the case where the blank portion is provided, a good result is obtained for both the carrier collecting performance evaluation and the roughness evaluation, so that compatibility between the carrier collecting performance and the image quality is achieved.

In an embodiment 1-2, a length of a blank portion is changed to a length corresponding to two wavelengths of a pulse portion relative to that in the embodiment 1-1. In the embodiment 1-2, similarly as in the embodiment 1-1, a good result was obtained for both the carrier collecting device evaluation and the roughness evaluation.

In an embodiment 1-3, a length of a blank portion is changed to a length corresponding to four wavelengths of a pulse portion relative to that in the embodiment 1-1. In the embodiment 1-3, compared with the embodiment 1-1, both the carrier collecting device evaluation and the roughness evaluation somewhat lower. This would be considered because when the blank portion is made excessively long, the number of times of the pulse portion in the collecting portion decreases and an amount of the carrier removed from the photosensitive drum 1 lowers, and thus the carrier collecting performance somewhat lowered. Similarly, the number of times of the re-arrangement of the toner lowers, so that the roughness evaluation also somewhat lowered. From this result, in one embodiment, the length of the blank portion is one time or more and four times or less of the wavelength of the AC voltage in the pulse portion (one wavelength to four wavelengths). In another embodiment, the length of the blank portion is one time or more and two times or less of the wavelength of the AC voltage in the pulse portion (one wavelength to two wavelengths).

In an embodiment 2, a duty ratio is made higher than the duty ratio in the embodiment 1-1. For both the carrier collecting performance evaluation and the roughness evaluation, in the embodiment 2, compared with the embodiment 1-1, a further good result was obtained. This would be considered because the carrier collection driving-side component of the pulse portion is increased when the duty ratio is increased, and not only the carrier collecting performance is improved but also the roughness evaluation is improved by decrease in toner collection driving-side component.

In an embodiment 3, a frequency of a pulse portion is made higher than the frequency in the embodiment 1-1, and thus is made higher than the frequency of the pulse portion of the developing bias. As regards the roughness evaluation, in the embodiment 3, a further good result was obtained compared with the result in the embodiment 1-1. This would be considered because by making the frequency of the pulse portion higher than the frequency of the developing bias, a variation in toner deposition onto the non-image portion due to re-arrangement of the toner in the carrier collecting region is decreased compared with the variation after passing through the developing region. On the other hand, by the increase in frequency of the pulse portion, a carrier movement distance per one time in the pulse portion is decreased, so that the carrier collecting performance evaluation somewhat lowered.

As described above, in this embodiment, when the image forming operation is executed, the carrier collecting bias such that the pulse portion where the DC voltage and the AC voltage are superposed with each other and the blank portion including only of the DC voltage are periodically repeated was applied to the collecting sleeve 51 of the carrier collecting device 5. By this, it is possible to compatibly achieve that the performance for collecting the carrier from the photosensitive drum to the collecting roller is improved and that disturbance of the image on the photosensitive drum is suppressed.

Incidentally, in the above-described embodiments, the double blank pulse was employed, but the pulse waveform may also be single blank pulse waveform such that the blank portion is provided after a pulse portion consisting of an AC voltage of a one-period rectangular wave.

Further, the image forming apparatus 100 is not limited to the full-color printer, but may also be a monochromatic or monocolor printer. Further, the image forming apparatus 100 may also be other printers, various printing machines, copying machines, facsimile machines, multi-function machines having a plurality of functions of these machines, and the like machines.

Further, the photosensitive drum 1 may be a drum-shaped organic photosensitive member, and it is also possible to use an inorganic photosensitive member such as an amorphous silicon photosensitive member. Further, a belt-shaped photosensitive member can also be used. As regards the charging type, the transfer type, the cleaning type, and the fixing type, these types are not limited to the above-described types. Also, the developing device is not limited to the constitution of the developing device 4 described above, with reference to FIG. 2 when the developing device employs the two-component development type using the carrier. For example, it is possible to apply the disclosure in a developing device in which the developing chamber and the stirring chamber are vertically disposed as used conventionally or in developing devices in other forms.

According to the disclosure, it is possible to compatibly achieve that the performance for collecting the carrier from the photosensitive drum to the collecting roller is improved and that disturbance of the image on the photosensitive drum is suppressed.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-204893 filed on Nov. 25, 2024, which is hereby incorporated by reference herein in its entirety.

What is claimed is:

1. An image forming apparatus capable of executing an image forming operation, comprising:
a rotatable image bearing member on which an electrostatic latent image is formed;
a developing device including a developing container configured to accommodate a developer containing toner and a carrier and including a developer carrying member configured to carry the developer for developing the electrostatic latent image, formed on the image bearing member, into a toner image;
a transfer member onto which the toner image borne on the image bearing member is transferred;
a carrier collecting device including a rotatable sleeve provided opposed to the image bearing member on a side, with respect to a rotational direction of the image bearing member, downstream of a developing position where the electrostatic latent image formed on the image bearing member is developed and upstream of a transfer position where the toner image borne on the image bearing member is transferred onto the transfer member, and including a magnet provided non-rotatably inside the sleeve, the carrier collecting device being configured to collect the carrier on the image bearing member;
a voltage applying portion configured to apply a voltage to the sleeve; and
a controller configured to control the voltage applying portion so that a carrier collecting bias such that a pulse portion where a DC voltage and an AC voltage are superposed with each other and a blank portion including only of the DC voltage are periodically repeated is applied to the sleeve when the image forming operation is executed.

2. The image forming apparatus according to claim 1, wherein in a case where of the AC voltage in the pulse portion, a voltage on a side opposite in polarity to a normal charge polarity of the carrier relative to a predetermined charge potential is Vcgo,
a waveform of the carrier collecting bias is a waveform such that the blank portion exists after the voltage Vcgo is applied.

3. The image forming apparatus according to claim 1, wherein a length of the blank portion is one time or more and four times or less of a waveform of the AC voltage in the pulse portion.

4. The image forming apparatus according to claim 1, wherein a length of the blank portion is one time or more and two times or less of a waveform of the AC voltage in the pulse portion.

5. The image forming apparatus according to claim 1, wherein a waveform of the carrier collecting bias is a waveform such that the blank portion exists after the pulse portion consisting of an AC voltage of a double blank pulse with a plurality of periods.

6. The image forming apparatus according to claim 1, wherein in a case where
of the AC voltage in the pulse portion, a voltage on a side opposite in polarity to a normal charge polarity of the carrier relative to a predetermined charge potential is Vcgo,
of the AC voltage in the pulse portion, a voltage on a side identical in polarity to the normal charge polarity of the carrier relative to the predetermined charge potential is Vcre, and
a duty ratio of the carrier collecting bias is Vcgo/(Vcgo+Vcre),
the duty ratio is more than 50% and 90% or less.

7. The image forming apparatus according to claim 1,
wherein a developing bias such that a DC voltage and AC voltage are superposed with each other is applied to the developer carrying member when the image forming operation is executed, and
wherein a frequency of the AC voltage in the pulse portion is higher than a frequency of the AC voltage of the developing bias.

8. The image forming apparatus according to claim 2, wherein a length of the blank portion is one time or more and four times or less of a waveform of the AC voltage in the pulse portion.

9. The image forming apparatus according to claim 2, wherein a length of the blank portion is one time or more and two times or less of a waveform of the AC voltage in the pulse portion.

10. The image forming apparatus according to claim 2, wherein a waveform of the collecting bias is a waveform such that the blank portion exists after the pulse portion consisting of an AC voltage of a double blank pulse with a plurality of periods.

11. The image forming apparatus according to claim 2, wherein in a case where
of the AC voltage in the pulse portion, a voltage on a side opposite in polarity to a normal charge polarity of the carrier relative to a predetermined charge potential is Vcgo,
of the AC voltage in the pulse portion, a voltage on a side identical in polarity to the normal charge polarity of the carrier relative to the predetermined charge potential is Vcre, and
a duty ratio of the collecting bias is Vcgo/(Vcgo+Vcre),
the duty ratio is more than 50% and 90% or less.

12. The image forming apparatus according to claim 2,
wherein a developing bias such that a DC voltage and AC voltage are superposed with each other is applied to the developer carrying member when the operation is executed, and
wherein a frequency of the AC voltage in the pulse portion is higher than a frequency of the AC voltage of the developing bias.

13. The image forming apparatus according to claim 3, wherein a length of the blank portion is one time or more and two times or less of a waveform of the AC voltage in the pulse portion.

14. The image forming apparatus according to claim 3, wherein a waveform of the carrier collecting bias is a waveform such that the blank portion exists after the pulse portion consisting of an AC voltage of a double blank pulse with a plurality of periods.

15. The image forming apparatus according to claim 3, wherein in a case where
of the AC voltage in the pulse portion, a voltage on a side opposite in polarity to a normal charge polarity of the carrier relative to a predetermined charge potential is Vcgo,
of the AC voltage in the pulse portion, a voltage on a side identical in polarity to the normal charge polarity of the carrier relative to the predetermined charge potential is Vcre, and
a duty ratio of the carrier collecting bias is Vcgo/(Vcgo+Vcre),
the duty ratio is more than 50% and 90% or less.

16. The image forming apparatus according to claim 3,
wherein a developing bias such that a DC voltage and AC voltage are superposed with each other is applied to the developer carrying member when the image forming operation is executed, and
wherein a frequency of the AC voltage in the pulse portion is higher than a frequency of the AC voltage of the developing bias.

17. The image forming apparatus according to claim 4, wherein a waveform of the collecting bias is a waveform such that the blank portion exists after the pulse portion consisting of an AC voltage of a double blank pulse with a plurality of periods.

18. The image forming apparatus according to claim 4, wherein in a case where
of the AC voltage in the pulse portion, a voltage on a side opposite in polarity to a normal charge polarity of the carrier relative to a predetermined charge potential is Vcgo,
of the AC voltage in the pulse portion, a voltage on a side identical in polarity to the normal charge polarity of the carrier relative to the predetermined charge potential is Vcre, and
a duty ratio of the collecting bias is Vcgo/(Vcgo+Vcre),
the duty ratio is more than 50% and 90% or less.

19. The image forming apparatus according to claim 4,
wherein a developing bias such that a DC voltage and AC voltage are superposed with each other is applied to the developer carrying member when the operation is executed, and
wherein a frequency of the AC voltage in the pulse portion is higher than a frequency of the AC voltage of the developing bias.

20. The image forming apparatus according to claim 5, wherein in a case where
of the AC voltage in the pulse portion, a voltage on a side opposite in polarity to a normal charge polarity of the carrier relative to a predetermined charge potential is Vcgo,
of the AC voltage in the pulse portion, a voltage on a side identical in polarity to the normal charge polarity of the carrier relative to the predetermined charge potential is Vcre, and
a duty ratio of the collecting bias is Vcgo/(Vcgo+Vcre),
the duty ratio is more than 50% and 90% or less.
